(19) United States
(12) Patent Application Publication
(10) Pub. No.: US 2015/0151687 A1
(43) Pub. Date: Jun. 4, 2015

(54) APPARATUS FOR HOLDING A FORK OF A MOUNTAIN BICYCLE

(71) Applicant: King Shen Co., Ltd., Taichung City (TW)

(72) Inventor: David TSAI, Taichung City (TW)

(73) Assignee: King Shen Co., Ltd., Taichung City (TW)

(21) Appl. No.: 14/095,305

(22) Filed: Dec. 3, 2013

(51) Int. Cl. B60R 9/048; B60R 9/10

(52) U.S. Cl. CPC B60R 9/048; B60R 9/10

(57) ABSTRACT

An attachment device is devised for attaching a fork of a mountain bicycle to a top of a car. The attachment device includes a frame, two supporting elements and a quick-release skewer. The frame includes two lateral members for attachment to the top of the car. Each of the supporting elements is attached to a corresponding one of the lateral members of the frame. Each of the supporting elements is adapted for supporting a free end of each prong of the fork. The quick-release skewer is operable for pressing the free end of each prong of the fork against a corresponding one of the lateral members of the frame.

### BACKGROUND OF INVENTION

1. Field of Invention

The present invention relates to a mountain bicycle and, more particularly, to an apparatus for holding a fork of a mountain bicycle.

2. Related Prior Art

U.S. Pat. No. 6,036,069 discloses a conventional attachment device 16 for attaching a special fork of a certain mountain bicycle to a typical carrier 10 secured to the roof of a vehicle. The fork of the mountain bicycle includes two prongs 20 and 22 each of which includes a looped free end instead of a recessed free end. The carrier 10 includes a threaded rod 12 and two nuts 14. The threaded rod 12 is secured to the roof of the vehicle. The attachment device 16 includes a tubular cross member 18, a threaded rod 24, two nuts 26 and two side protections 28 and 30. The side projections 28 and 30 are secured to the tubular cross member 18 by welding. Each of the side projections 28 and 30 includes an opening 32. In use, the tubular cross member 18 of the attachment device 16 is placed between the looped free ends of the prongs 20 and 22 before the threaded rod 24 is inserted in the tubular cross member 18 and the looped free ends. The nuts 26 are engaged with the threaded rod 24, thus firmly connecting the fork to the attachment device 16. The side projections 28 and 30 are placed on the threaded rod 12. That is, the threaded rod 12 is placed in the openings 32 of the side projections 28 and 30. Finally, the nuts 14 are engaged with the threaded rod 12. Thus, the fork of the mountain bicycle is attached to a typical carrier 10 by the attachment device 16. The use of the attachment device 16 is however not without any problem. At first, the connection of the side projections 28 and 30 to the tubular cross member 18 is by welding and hence vulnerable to rust. Secondly, the connection of the fork to the attachment device 16 is by the engagement of the nuts 26 with the threaded rod 24 and therefore troublesome.

Therefore, the present invention is intended to obviate or at least alleviate the problems encountered in prior art.

### SUMMARY OF INVENTION

It is the primary objective of the present invention to provide a reliable and convenient attachment device for attaching a fork of a mountain bicycle to a typical carrier.

To achieve the foregoing objective, the attachment device includes a frame, two supporting elements and a quick-release skewer. The frame includes two lateral members for attachment to the top of the car. Each of the supporting elements is attached to a corresponding one of the lateral members of the frame. Each of the supporting elements is adapted for supporting a free end of each prong of the fork. The quick-release skewer is operable for pressing the free end of each prong of the fork against a corresponding one of the lateral members of the frame.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is an exploded view of an attachment device according to the preferred embodiment of the present invention;

FIG. 2 is a perspective view of the attachment device of FIG. 1;

FIG. 3 is a cross-sectional view of a conventional fork of a mountain bicycle supported on the attachment device shown in FIG. 2; and

FIG. 4 is a perspective view of another conventional fork of a mountain bicycle supported on a car by the attachment device shown in FIG. 1.

### DETAILED DESCRIPTION OF PREFERRED EMBODIMENT

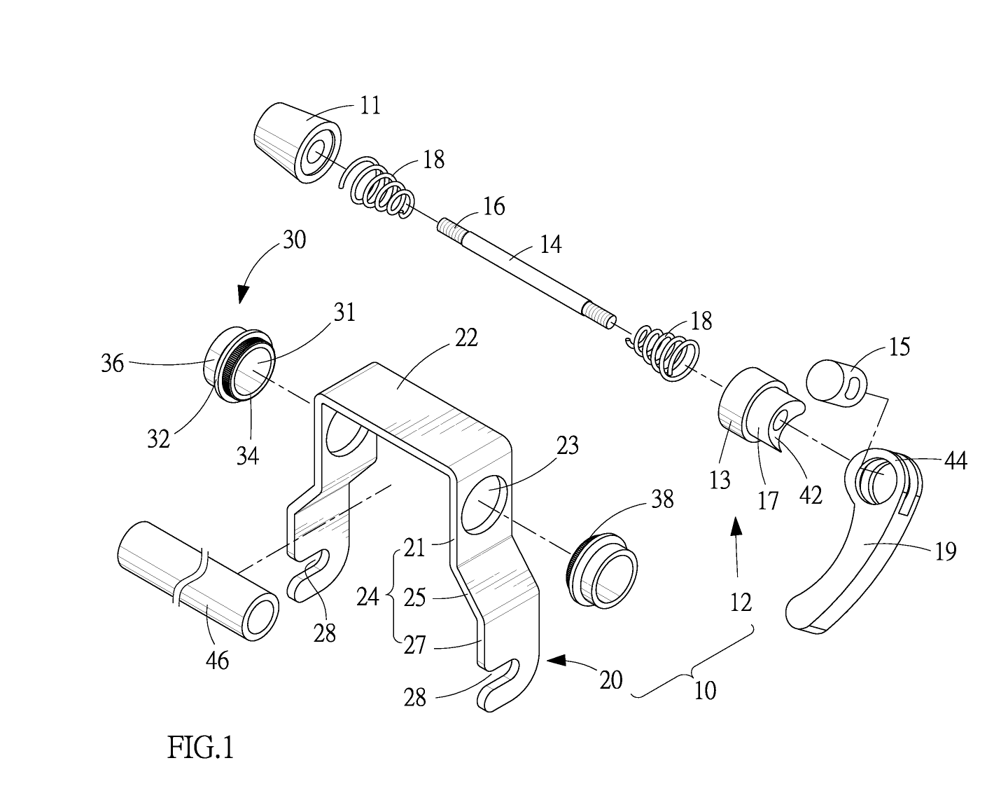

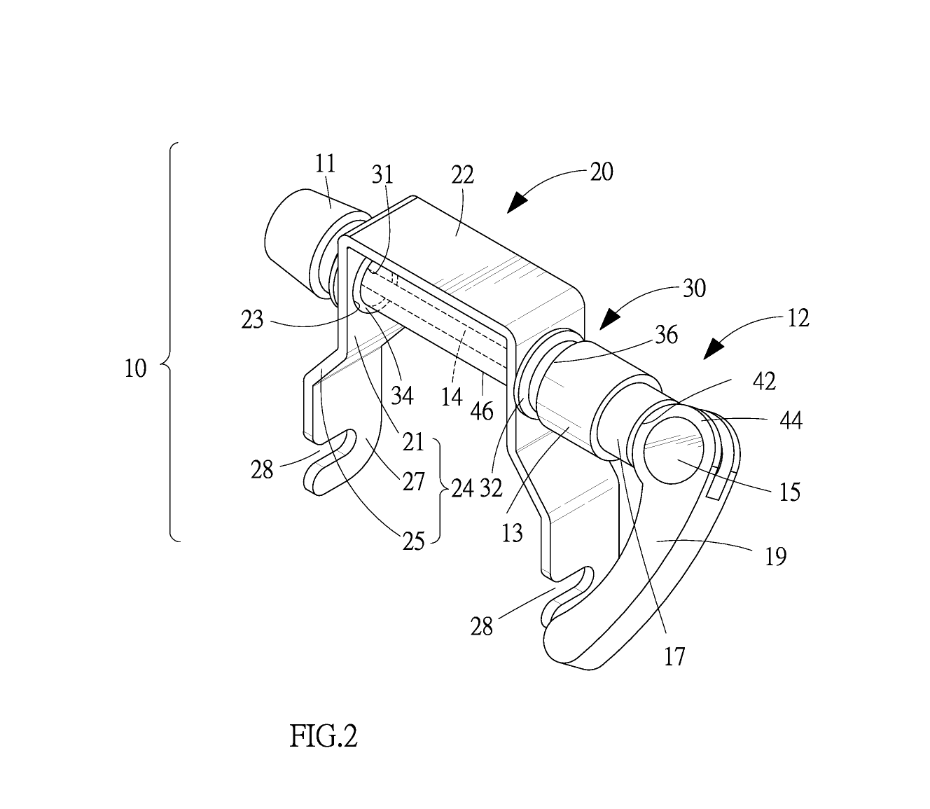

Referring to FIGS. 1 to 3, there is an attachment device 10 according to the preferred embodiment of the present invention. The attachment device 10 includes a quick release skewer 12, a frame 20, two supporting elements 30 and a tube 46.

The frame 20 includes a cross member 22 formed between two lateral members 24. The frame 20 is made of a strip of steel or aluminum alloy for example. That is, the cross member 22 and the lateral members 24 are one. Hence, the connection of the cross member 22 to each of the lateral members 24 is less vulnerable to rust than those made by welding. Each of the lateral members 24 includes a middle portion 25 extending to a lower portion 27 from an upper portion 21. The middle portions 25 of the lateral members 24 extend a slant manner so that the upper portions 21 of the lateral members 24 are closer to each other than the lower portions 27 are to each other. The upper portion 21 is made with an aperture 23. The lower portion 27 includes a cutout 28.

The tube 46 is placed between the upper portions 21 of the lateral members 24. Preferably, each end of the tube 46 is in contact with the upper portion 21 of a corresponding one of the lateral members 24. To this end, the length of the tube 46 is made identical to the distance between the upper portions 21 of the lateral members 24.

Each of the supporting elements 30 includes a tunnel 31 made therein to render each of the supporting elements 30 annular or tubular. Each of the supporting elements 30 includes an annular rib 32 formed between to two portions 34 and 36. Teeth 38 are formed on the first portion 34 of each of the supporting elements 30. The first portion 34 of each of the supporting elements 30 is inserted in the aperture 23 of a corresponding one of the lateral members 24.

The quick-release skewer 12 includes a nut 11, a collar 13, a rod 14, a is shaft 15, a follower 17, two springs 18 and a lever 19. The rod 14 is formed with two threads 16. The follower 17 is formed With a concave face 42. The lever 19 includes two cams or lugs 44. Each of the cams 44 of course includes a lobe for contact with the concave face 42. The shaft 15 includes two portions each inserted in a corresponding one of the cams 44 so that the cams 44 are rotatable on the shaft 15. The follower 17 includes a portion placed in the collar 13. An end of the rod 14 is directed through the first spring 18, the follower 17 and the collar 13 before the first thread 16 is inserted in a screw hole made in the shaft 15. Another end of the rod 14 is directed through the second spring 18 before the second thread 16 is inserted in the nut 11.

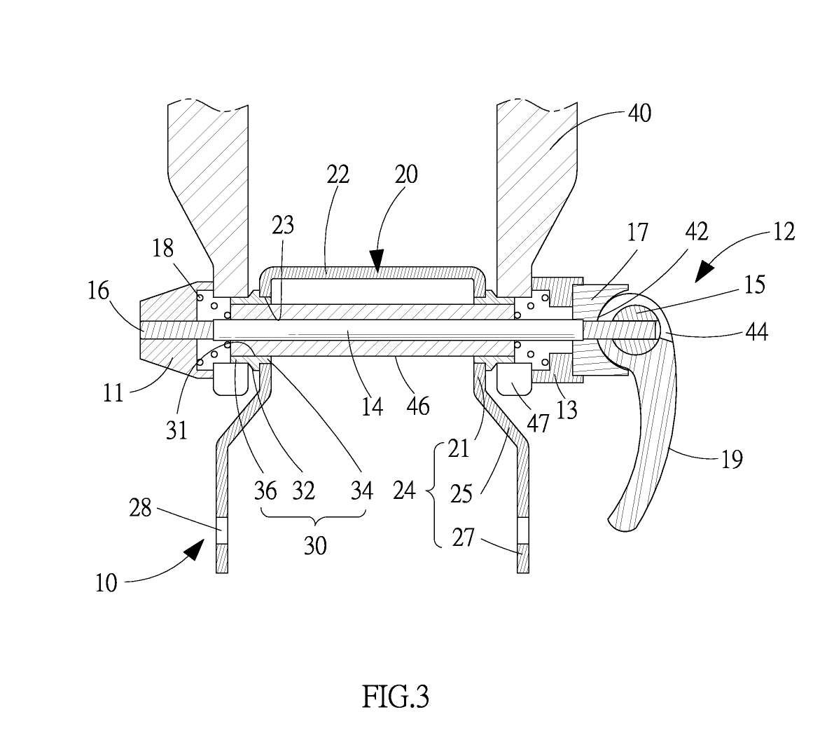

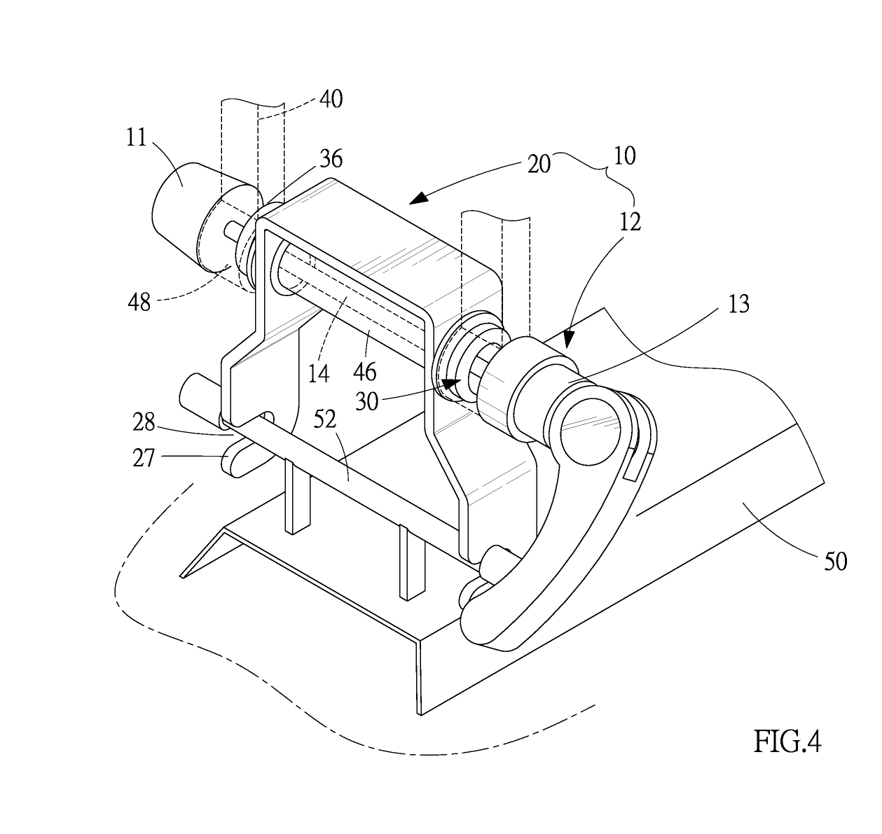

Referring to FIGS. 3 and 4, a yoke 52 is secured to a top 50 of a car. Two portions of the yoke 52 are inserted in the cutouts 28 of the lateral members 24 of the frame 20. Thus, the frame 20 is mounted on the yoke 52. The frame 20 is kept on the yoke 52 in a conventional manner that will not be described in detail.

Referring to FIG. 3, there is a fork 40 that includes two prongs each formed with a split free end 47. The split free end 47 of each of the prongs of the fork 40 is mounted on the second portion 36 of a corresponding one of the supporting elements 30. The lever 19 is pivoted to place the lobes of the cams 44 against the concave face 42 of the follower 17. Thus, the collar 13 is placed against the split free end 47 of one of the prongs of the fork 40 while the nut 11 is placed against the split free end 47 of the other prong of the fork 40.

Referring to FIG. 4, there is a fork 40 that includes two prongs each formed with a looped free end 48. The second portion 36 of each of the supporting elements 30 is inserted in the looped free end 48 of a corresponding one of the prongs of the fork 40. The lever 19 is pivoted to place the lobes of the cams 44 against the concave face 42 of the follower 17. Thus, the collar 13 is placed against the looped free end 48 of one of the prongs of the fork 40 while the nut 11 is placed against the looped free end 48 of the other prong of the fork 40.

The width of the second portion 36 of each supporting element 30 is smaller than that of the looped free end 48 of each prong of the fork 40 (FIG. 3) to render easy the insertion of the second portion 36 of each supporting element 30 in the looped free end 48 of the corresponding prong of the fork 40. However, the width of the second portion 36 of each supporting element 30 must be sufficient in comparison with that of each prong of the fork 40 to provide adequate support for the looped free end 48 of the corresponding prong of the fork 40. Preferably, the width of the second portion 36 of each supporting element 30 is about half of that of each prong of the fork 40.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. An attachment device for attaching a fork of a mountain bicycle to a top of a car, the attachment device including:
a frame including two lateral members for attachment to the top of the car;
two supporting elements each attached to a corresponding one of the lateral members of the frame, wherein each of the supporting elements is adapted for supporting a free end of each prong of the fork; and
a quick-release skewer operable for pressing the free end of each prong of the fork against a corresponding one of the lateral members of the frame.

2. The attachment device according to claim 1, wherein each of the lateral members of the frame includes an aperture for receiving a corresponding one of the supporting elements.

3. The attachment device according to claim 2, wherein each of the supporting elements includes a first portion inserted in the aperture of the corresponding lateral member of the frame and a second portion for supporting the free end of the corresponding prong of the fork.

4. The attachment device according to claim 3, wherein the first portion of each of the supporting elements is made with width smaller than that of each prong of the fork.

5. The attachment device according to claim 4, wherein the width of the first portion of each of the supporting elements is half of that of each prong of the fork.

6. The attachment device according to claim 3, wherein each of the supporting elements includes teeth formed on the second portion thereof.

7. The attachment device according to claim 3, wherein each of the supporting elements includes an annular rib formed between the first and second portions thereof, wherein rib is placed against the corresponding lateral member.

8. The attachment device according to claim 1, wherein each of the lateral members of the frame includes a cutout for receiving a yoke secured to the top of the car.

9. The attachment device according to claim 1, wherein each of the supporting elements includes a tunnel for receiving the quick-release skewer.

10. The attachment device according to claim 1, including a tube placed between the lateral members of the frame, wherein the quick-release skewer is inserted in the tube.
